(19) United States
(12) Patent Application Publication
(10) Pub. No.: US 2017/0336888 A1
(43) Pub. Date: Nov. 23, 2017

(54) TOUCH SENSING CIRCUIT AND IN-CELL DISPLAY PANEL USING THE SAME

(71) Applicant: HIMAX TECHNOLOGIES LIMITED, Tainan City (TW)

(72) Inventors: Hui-Min WANG, Tainan City (TW); Yaw-Guang CHANG, Tainan City (TW)

(21) Appl. No.: 15/156,344

(22) Filed: May 17, 2016

(51) Int. Cl. G06F 3/044

(52) U.S. Cl. CPC G06F 3/044

(57) ABSTRACT

The prevent disclosure is directed to a touching sensing circuit for an in-cell display panel. An electrode is disposed between two substrates of the in-cell display panel. An operational amplifier has a first input terminal coupled to the electrode. A signal generating circuit is coupled to a second input terminal of the operational amplifier and outputs a programmable signal during a touch sensing period. A capacitor is coupled between the first input terminal and an output terminal of the operational amplifier. A comparator has a first input terminal coupled to the output terminal of the operational amplifier, and a second input terminal coupled to a reference voltage. A feedback circuit is coupled between the output terminal of the comparator and the first input terminal of the operational amplifier. The programmable signal does not have a square waveform, and no switch is disposed between the operational amplifier and the electrode.

### BACKGROUND

### Field of Invention

The present invention relates to a display panel. More particularly, the present invention relates to an in-cell display panel and a sensing touch circuit thereof.

### Description of Related Art

In an in-cell display panel, a touch electrode is disposed between two substrates. The touch electrode is electrically connected to a common voltage during a display period. The touch electrode is used for displaying images incorporating with elements such as a thin film transistor (TFT) and liquid crystal. The touch electrode is also coupled to a touch sensing circuit for detecting a capacitance variation on the touch electrode during a touch sensing period so as to determine whether a finger is approaching the display panel.

FIG. 1 is a circuit diagram illustrating a touch sensing circuit according to prior art. Referring to FIG. 1, a touch electrode 110 equivalently has a capacitor Cₜ, and is coupled to the touch sensing circuit 100 through a sensing line 160. The touch sensing circuit 100 includes a charge reducer 120, a charge adder 130, an operational amplifier 140, a capacitor C1, a comparator 150, an adder 111 and an adder 112. The capacitor C1 is coupled between an inversing input terminal and an output terminal of the operational amplifier 140. The non-inversing input terminal of the operational amplifier 140 is coupled to a reference voltage VH which is 4 volts. The adder 111 is coupled to a voltage VL (e.g. 0 volt) through a switch SW1, and is coupled to the charge reducer 120 through a switch SW2. A switch SW3 is disposed between the adder 112 and the adder 111. The switch SW1 is controlled by a phase signal φ₁, and the switch SW2 and the switch SW3 are controlled by a phase signal φ₂. The phase signal φ₁ is phase-inverted and not overlapped from/with the phase signal φ₂. In detail, when the switch SW1 is on (i.e. the switches SW2 and SW3 are off), the voltage VL discharges the capacitor Cₜ. When the switches SW2 and switch SW3 are on (i.e. the switch SW1 is off), the voltage VH charges the capacitor Cₜ because the two input terminals of the operational amplifier 140 is virtually shorted. The charge reducer 120 is used to equivalently decrease the charges on the capacitor Cₜ, and thus the output of the operational amplifier 140 does not exceed its operation range. The capacitor C1 and the operational amplifier 140 form an integrator, and the output of the integrator is compared with a reference voltage VR by the comparator 150. The output of the comparator 150 is fed back to the adder 112 through the charge adder 130. When the voltage VH charges the capacitor Cₜ, it is equivalent to applying a square-wave signal on the sensing line 160. The sensing line 160 may have high-frequency noises, and the noises would be folded, in a frequency domain, into a main band through the operations of the switches SW1, SW2 and SW3. As a result, when a band pass filtering is performed on the output of the comparator 150, the noises cannot be removed.

### SUMMARY

One aspect of the present disclosure provides a touch sensing circuit for an in-cell display panel. The in-cell display panel includes a first substrate, a first electrode and a second substrate. The first electrode is disposed between the first substrate and the second substrate. The touch sensing circuit includes an operational amplifier, a signal generating circuit, a capacitor, a comparator, and a feedback circuit. The operational amplifier has a first input terminal coupled to the first electrode, and a second input terminal. The signal generating circuit is coupled to the second input terminal of the operational amplifier. The capacitor is coupled between the first input terminal of the operational amplifier and an output terminal of the operational amplifier. The comparator has a first input terminal coupled to the output terminal of the operational amplifier, and a second input terminal coupled to a reference voltage. The feedback circuit is coupled between the output terminal of the comparator and the first input terminal of the operational amplifier. The signal generating circuit outputs a programmable signal to the second input terminal of the operational amplifier during a touch sensing period. The programmable signal does not have a square waveform, and no switch is disposed between the first input terminal of the operational amplifier and the first electrode.

In some embodiments, the signal generating circuit includes a digital-to-analog converter and a waveform generator. The digital-to-analog converter has an output terminal coupled to the second input terminal of the operational amplifier. The waveform generator is coupled to an input terminal of the digital-to-analog converter, and the waveform generator generates a digital signal to the digital-to-analog converter.

In some embodiments, the feedback circuit includes a digital-to-analog converter and an adder. The digital-to-analog converter has an input terminal coupled to the output terminal of the comparator. The adder has two input terminals respectively coupled to the first electrode and an output terminal of the digital-to-analog converter, wherein an output terminal of the adder is coupled to the first input terminal of the operational amplifier.

In some embodiments, the touch sensing circuit further includes a digital filter which is coupled to the output terminal of the comparator.

In some embodiments, the programmable signal has a triangular waveform.

In some embodiments, the first electrode is electrically connected to a common voltage during a display period.

Another aspect of the present disclosure provides an in-cell display panel including a first substrate, a second substrate, a first electrode and a touch sensing circuit. The first electrode is disposed between the first substrate and the second substrate. The touch sensing circuit includes an operational amplifier, a signal generating circuit, a capacitor, a comparator, and a feedback circuit. The operational amplifier has a first input terminal coupled to the first electrode, and a second input terminal. The signal generating circuit is coupled to the second input terminal of the operational amplifier. The capacitor is coupled between the first input terminal of the operational amplifier and an output terminal of the operational amplifier. The comparator has a first input terminal coupled to the output terminal of the operational amplifier, and a second input terminal coupled to a reference voltage. The feedback circuit is coupled between the output terminal of the comparator and the first input terminal of the operational amplifier. The signal generating circuit outputs a programmable signal to the second input terminal of the operational amplifier during a touch sensing period. The programmable signal does not have a square waveform, and no switch is disposed between the first input terminal of the operational amplifier and the first electrode.

### BRIEF DESCRIPTION OF THE DRAWINGS

The invention can be more fully understood by reading the following detailed description of the embodiment, with reference made to the accompanying drawings as follows.

FIG. 1 is a circuit diagram illustrating a touch sensing circuit according to prior art.

FIG. 2 is a schematic diagram illustrating a display panel according to an embodiment.

FIG. 3 is a circuit diagram illustrating the touch sensing circuit according to an embodiment.

FIG. 4 is a diagram illustrating the waveform on the input terminal and the output terminal of a comparator according to an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence. In addition, the “couple” used in the specification should be understood for electrically connecting two units directly or indirectly. In other words, when “a first object is coupled to a second object” is written in the specification, it means another object may be disposed between the first object and the second object.

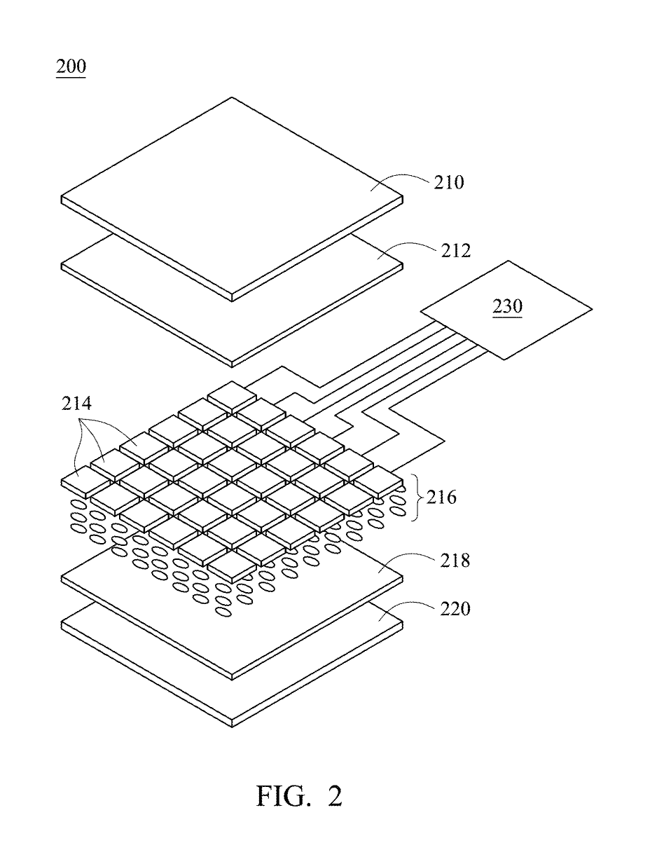

FIG. 2 is a schematic diagram illustrating a display panel according to an embodiment. Referring to FIG. 2, an in-cell display panel 200 includes a first substrate 210 and a second substrate 220. A color filter 212, multiple electrode 214 (also referred to first electrodes), liquid crystal 216 and a driving structure 218 are disposed between the first substrate 210 and the second substrate 220. The electrodes 214 are coupled to a touch sensing circuit 230. For simplification, not all units of the in-cell display panel 200 are shown in FIG. 2.

The material of the first substrate 210 and the second substrate 220 may include glass. The material of the electrodes 214 includes, for example, indium tin oxide (ITO), indium zinc oxide (IZO), antimony tin oxide (ATO), fluorine tin oxide (FTO), or other conductive and transparent material.

The driving structure 218 includes multiple thin film transistors (TFTs), and each TFT is coupled to a pixel electrode. During the display period, the electrodes 214 are electrically connected to a common voltage, and the TFTs drive the pixel electrodes according to the image to be displayed. Consequently, a particular electric field is generated between the electrodes 214 and the pixel electrodes of the driving structure 218 to control the orientation of the liquid crystal 216. During the touch sensing period, the touch sensing circuit 230 detects a capacitance variation on the electrodes 214 to determine whether a finger (or a touch pen) is approaching the display panel 200.

Note that the configuration in FIG. 2 is just an example, and the invention is not limited thereto. For example, in another embodiment, the electrodes 214 may be disposed between the liquid crystal 216 and the driving structure 218, or in the driving structure 218, and the electrodes 214 are electrically insulated from the pixel electrodes. In addition, the number and the arrangement of the electrodes 214 are not limited in the invention.

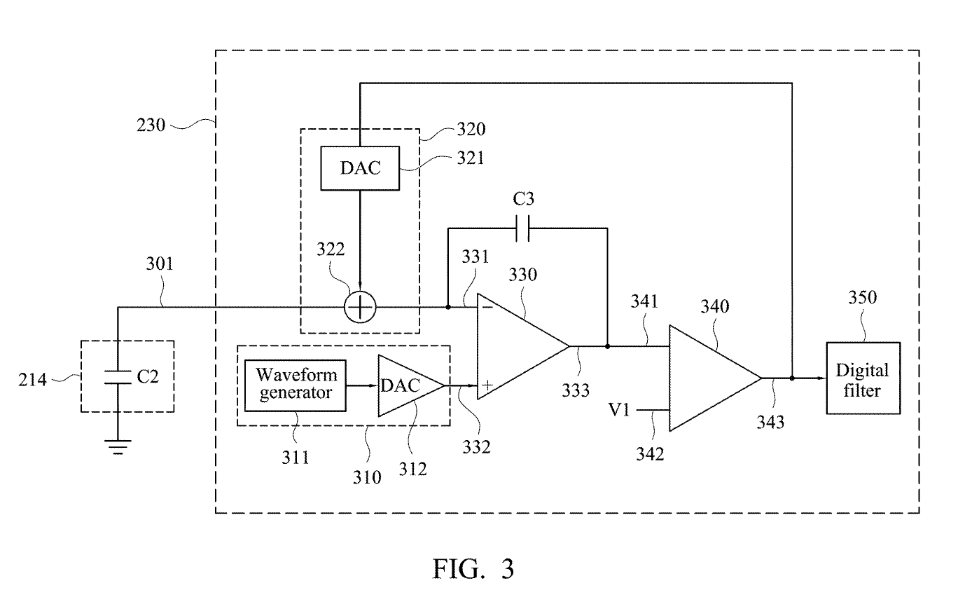

FIG. 3 is a circuit diagram illustrating the touch sensing circuit according to an embodiment. Referring to FIG. 3, the electrode 214 equivalently has a capacitor C2 which is coupled to the touch sensing circuit 230 through a sensing line 301. The touch sensing circuit 230 includes a signal generating circuit 310, a feedback circuit 320, an operational amplifier 330, a capacitor C3, and a comparator 340. A first input terminal 331 (e.g. inverting terminal) of the operational amplifier 330 is coupled to the electrode 214. A second input terminal 332 (e.g. non-inverting terminal) of the operational amplifier 330 is coupled to the signal generating circuit 310. The capacitor C3 is coupled between the first input terminal 331 and an output terminal 333 of the operational amplifier 330. A first input terminal 341 of the comparator 340 is coupled to the output terminal 333 of the operational amplifier 330. A second input terminal 342 of the comparator 340 is coupled to a reference voltage V1. The feedback circuit 320 is coupled between an output terminal 343 of comparator 340 and the first input terminal 331 of operational amplifier 330. The feedback circuit 320 includes, for example, a digital-to-analog converter 321 and an adder 322. An input terminal of the digital-to-analog converter 321 is coupled to the output terminal 343 of the comparator 340. Two input terminals of the adder 322 are respectively coupled to the first electrode 214 and the output terminal of the digital-to-analog converter 321, and an output terminal of the adder 322 is coupled to the first input terminal 331. The signal generating circuit 310 includes, for example, a waveform generator 311 and a digital-to-analog converter (DAC) 312. The digital-to-analog converter 312 has an input terminal coupled to the waveform generator 311, and an output terminal coupled to the second input terminal 332 of the operational amplifier 330. The waveform generator 311 outputs a digital signal to the digital-to-analog converter 312 which generates a corresponding signal according to the digital signal to the second input terminal 332.

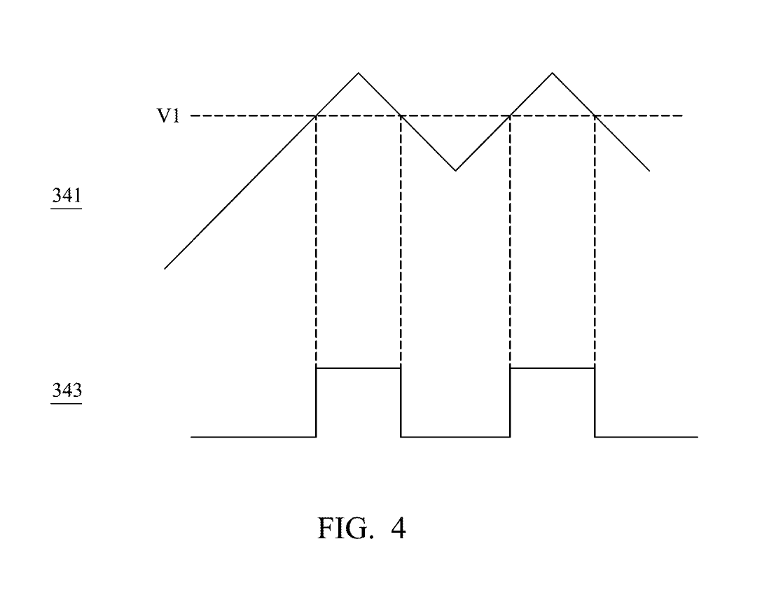

In particular, there is no switch disposed between the first input terminal 331 of the operational amplifier 330 and the electrode 214. In addition, during the touch sensing period, the signal generating circuit 310 outputs a programmable signal to the second input terminal 332 of the operational amplifier 330. The programmable signal is configured to gradually raise and fall, and does not have a square waveform. For example, the programmable signal has a triangular waveform or another waveform which gradually changes its magnitude. Because the two input terminals of the operational amplifier 330 are virtually shorted, the programmable signal is equivalently applied on the first input terminal 331 to charge the capacitor C2. In response to a touch on the display panel 200 around the electrode 214, the capacitance of the capacitor C2 increases, and thus the capacitor C2 is charged relatively slower. The capacitor C3 and the operational amplifier 330 form an integrator, and the output of the integrator is compared with a reference voltage V1 (e.g., 2.5 volts) by the comparator 340. In the embodiment, when the voltage on the output terminal 333 of the operational amplifier 330 is greater than the reference voltage V1, the comparator 340 outputs a first logical signal “1”, and the digital-to-analog converter (DAC) 321 generates a corresponding analog signal according to the first logical signal to the added 332 for decreasing the voltage on the electrode 214. In contrast, when the voltage on the output terminal 333 of the operational amplifier 330 is less than the reference voltage V1, the comparator 340 outputs a second logical signal “0”, and the digital-to-analog converter 321 generates a corresponding analog signal according to the second logical signal to the adder 332 for increasing the voltage on the electrode 214. In other words, the feedback circuit 320, the operational amplifier 330, the capacitor C3 and the comparator 340 form a sigma-delta converter, and the corresponding waveforms are shown in FIG. 4, in which the voltage on the input terminal 341 changes back and forth around the reference voltage V1, and pluses are correspondingly generated on the output terminal 343.

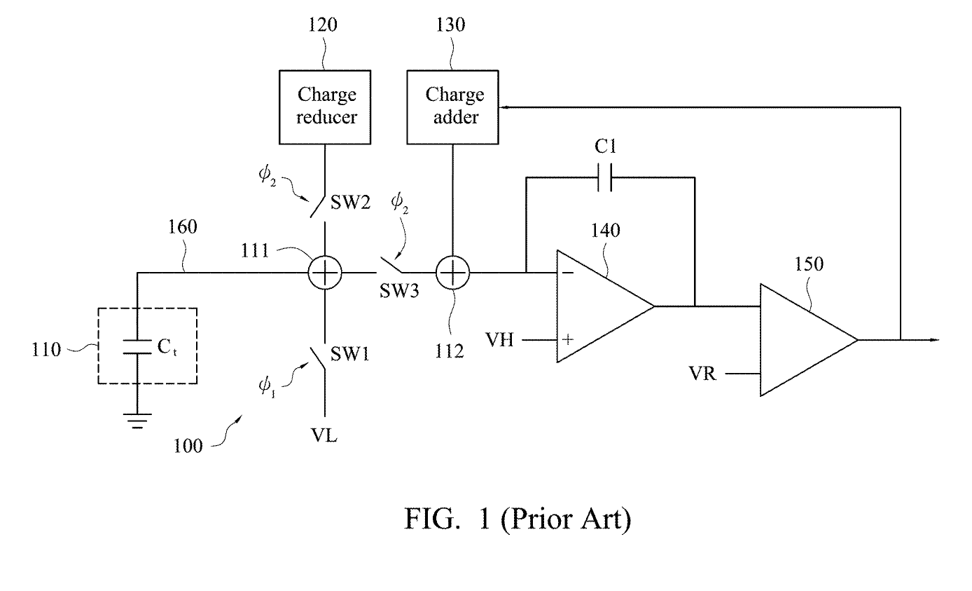

Referring to FIG. 3 again, the touch sensing circuit 230 further includes a digital filter 350 coupled to the output terminal of the comparator 340 in some embodiment. It is worth mentioning that, compared with the prior art of FIG. 1, there is no switch between the operational amplifier 330 and the electrode 214. That is, the embodiment does not use a switch to charge the capacitor C2, and thus the noises on the sensing line 301 are not folded into the main band. Consequently, the digital filter 350 is capable of filtering out the noises. On the other hand, the number of the charges on the capacitor C2 gradually changes due to the smooth programmable signal instead of the square waveform. Therefore, the output voltage of the operational amplifier 330 is less likely to exceed its operation range. Compared to the prior art of FIG. 1, the charge reducer is not required in FIG. 3.

In the embodiment, the signal generating circuit 310 includes the waveform generator 311 and the digital-to-analog converter 312, but person skilled in the art should be able to design another suitable circuit according to the functions of the signal generating circuit 310. Similarly, the feedback circuit 320 is not limited to the digital-to-analog converter 321 and the adder 322.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch sensing circuit for an in-cell display panel, wherein the in-cell display panel comprises a first substrate, a first electrode and a second substrate, and the first electrode is disposed between the first substrate and the second substrate, and the touch sensing circuit comprises:
an operational amplifier, having a first input terminal coupled to the first electrode, and a second input terminal,
a signal generating circuit, coupled to the second input terminal of the operational amplifier;
a capacitor, coupled between the first input terminal of the operational amplifier and an output terminal of the operational amplifier;
a comparator, having a first input terminal coupled to the output terminal of the operational amplifier, and a second input terminal coupled to a reference voltage; and
a feedback circuit, coupled between the output terminal of the comparator and the first input terminal of the operational amplifier,
wherein the signal generating circuit outputs a programmable signal to the second input terminal of the operational amplifier during a touch sensing period, the programmable signal does not have a square waveform, and no switch is disposed between the first input terminal of the operational amplifier and the first electrode.

2. The touch sensing circuit of claim 1, wherein the signal generating circuit comprises:
a digital-to-analog converter, having an output terminal coupled to the second input terminal of the operational amplifier; and
a waveform generator, coupled to an input terminal of the digital-to-analog converter, and the waveform generator generates a digital signal to the digital-to-analog converter.

3. The touch sensing circuit of claim 1, wherein the feedback circuit comprises:
a digital-to-analog converter, having an input terminal coupled to the output terminal of the comparator; and
an adder, having two input terminals respectively coupled to the first electrode and an output terminal of the digital-to-analog converter, wherein an output terminal of the adder is coupled to the first input terminal of the operational amplifier,
wherein when the comparator outputs a first logical signal indicating that a voltage on the output terminal of the operational amplifier is greater than the reference voltage, the digital-to-analog converter generates a first signal according to the first logical signal to the adder for decreasing a voltage on the first electrode,
wherein when the comparator outputs a second logical signal indicating that the voltage on the output terminal of the operational amplifier is less than the reference voltage, the digital-to-analog converter generates a second signal according to the second logical signal to the adder for increasing the voltage on the first electrode.

4. The touch sensing circuit of claim 1, further comprising:
a digital filter, coupled to the output terminal of the comparator.

5. The touch sensing circuit of claim 1, wherein the programmable signal has a triangular waveform.

6. The touch sensing circuit of claim 1, wherein the first electrode is electrically connected to a common voltage during a display period.

7. An in-cell display panel, comprising:
a first substrate;
a second substrate;
a first electrode, disposed between the first substrate and the second substrate; and
a touch sensing circuit, comprising:
an operational amplifier, having a first input terminal coupled to the first electrode, and a second input terminal,
a signal generating circuit, coupled to the second input terminal of the operational amplifier;
a capacitor, coupled between the first input terminal of the operational amplifier and an output terminal of the operational amplifier;
a comparator, having a first input terminal coupled to the output terminal of the operational amplifier, and a second input terminal coupled to a reference voltage; and
a feedback circuit, coupled between the output terminal of the comparator and the first input terminal of the operational amplifier,
wherein the signal generating circuit outputs a programmable signal to the second input terminal of the operational amplifier during a touch sensing period, the programmable signal does not have a square waveform, and no switch is disposed between the first input terminal of the operational amplifier and the first electrode.

8. The in-cell display panel of claim 7, wherein the signal generating circuit comprises:
a digital-to-analog converter, having an output terminal coupled to the second input terminal of the operational amplifier; and
a waveform generator, coupled to an input terminal of the digital-to-analog converter, and the waveform generator generates a digital signal to the digital-to-analog converter.

9. The in-cell display panel of claim 7, wherein the feedback circuit comprises:
a digital-to-analog converter, having an input terminal coupled to the output terminal of the comparator; and
an adder, having two input terminals respectively coupled to the first electrode and an output terminal of the digital-to-analog converter, wherein an output terminal of the adder is coupled to the first input terminal of the operational amplifier,
wherein when the comparator outputs a first logical signal indicating that a voltage on the output terminal of the operational amplifier is greater than the reference voltage, the digital-to-analog converter generates a first signal according to the first logical signal to the adder for decreasing a voltage on the first electrode,
wherein when the comparator outputs a second logical signal indicating that the voltage on the output terminal of the operational amplifier is less than the reference voltage, the digital-to-analog converter generates a second signal according to the second logical signal to the adder for increasing the voltage on the first electrode.

10. The in-cell display panel of claim 7, wherein the touch sensing circuit further comprises:
a digital filter, coupled to the output terminal of the comparator.

11. The in-cell display panel of claim 7, wherein the programmable signal has a triangular waveform.

12. The in-cell display panel of claim 7, wherein the first electrode is electrically connected to a common voltage during a display period.
